(19) United States
(12) Patent Application Publication
(10) Pub. No.: US 2019/0283150 A1
(43) Pub. Date: Sep. 19, 2019

(54) ROTARY CUTTING TOOL

(71) Applicant: Stojan Stojanovski, Shelby Township, MI (US)

(72) Inventor: Stojan Stojanovski, Shelby Township, MI (US)

(21) Appl. No.: 16/368,053

(22) Filed: Mar. 28, 2019

Related U.S. Application Data
(63) Continuation-in-part of application No. 15/684,354, filed on Aug. 23, 2017, now abandoned.
Application No. 15/684,354 is a continuation-in-part of application No. 15/373,061, filed on Dec. 8, 2016, now abandoned.
Application No. 15/373,061 is a continuation of application No. 14/078,862, filed on Nov. 13, 2013, now Pat. No. 9,545,678.
(60) Provisional application No. 61/727,446, filed on Nov. 16, 2012.

(51) Int. Cl. B23C 5/10

(52) U.S. Cl. CPC B23C 5/10; B23C 5/1009; B23C 2226/61; B23C 2210/54; B23C 2210/486; B23C 2210/206; Y10T 407/1962; B23C 2210/086; B23C 2210/0485; B23C 2210/02; B23C 2226/62; B23C 2210/40

(57) ABSTRACT

A rotatable cutting tool includes an elongate body and at least one helical flute extending over a length of the elongate body, the helical flute having a first end and a second end. The flute includes a cutting-edge with a first radius from a longitudinal center of the cutting tool, a trailing edge with a second radius from a longitudinal center of the cutting tool, wherein the second radius is smaller than the first radius, a flute surface between the cutting-edge and the trailing edge, the flute surface including a maximum radius at the cutting-edge and a plurality of foam chip shedding exclusions spaced along the cutting-edge of the helical flute, each of the foam chip shedding exclusions providing a gap in the cutting-edge where the radius within the gap is smaller than the first radius. The first radius defines a maximum tool cutting radius for the cutting tool. A gap distance between the foam chip shedding exclusions and the maximum tool cutting radius equals at least 15% of a radial height of the flute.

### CROSS REFERENCE TO RELATED APPLICATIONS

This application is a continuation-in-part of U.S. patent application Ser. No. 15/684,354, filed on Aug. 23, 2017, which is a continuation-in-part of U.S. patent application Ser. No. 15/373,061, filed on Dec. 8, 2016, which is a continuation of U.S. patent application Ser. No. 14/078,862, filed on Nov. 13, 2013, which claims the benefit of U.S. Provisional Patent Application No. 61/727,446, filed Nov. 16, 2012, all of which are incorporated herein by reference.

### TECHNICAL FIELD

The present disclosure relates generally to an improved rotary cutting tool. More particularly, the present disclosure relates to an improved rotary cutting tool for use in milling a workpiece made from a foam material.

### BACKGROUND

The statements in this section merely provide background information related to the present disclosure. Accordingly, such statements are not intended to constitute an admission of prior art.

Rotary cutting tools, including milling tools, can be used for various machining operations on workpieces. Such machine operations can be generically referred to as milling operations and include the forming of slots, keyways, pockets, and the like, along with the removal of material to achieve a net location of the material for a finished product. Several considerations related to end-mill tool design include time for completing a machining operation, amount of material removed in a cut, quality of the cut, and wear on the tool itself during the milling operation.

The various machining operations performed with a rotary cutting tool can be performed in a “roughing” mode (rough cutting) and a “finishing” mode (finish cutting). During roughing, material is removed from a workpiece at a relatively high rate (e.g., depth of cut), but with a relatively rough surface finish. Finish cutting involves the removal of material from a workpiece at a relatively low rate, but with a relatively smooth surface finish. Generally, these two operations (roughing and finishing) are antithetical to one another, and commonly require two operations with two different cutting tools.

Rotary cutting tools can be commonly formed from materials such as tungsten carbide, high speed steel, ceramic, and other advanced materials and coatings and typically include a “shank” portion, a “body” portion and a “point”. The shank portion is located towards one (proximal or first) end of the tool and is generally cylindrical (and may be tapered) for engagement by a spindle of a milling machine. In use, the milling machine rotatably drives the tool about its longitudinal axis. The main or body portion of the tool is located between the shank and the opposite (distal or second) end or point. The point is formed at an opposite end of the tool from the shank portion, and typically includes one or more cutting edges. To manufacture an end-mill tool, a grinder is typically used to grind a flute face and a corresponding cutting edge on the body of the end-mill tool. The grind (grinding operation) typically starts from a position adjacent an end of the body portion and continues to a point at or near the interface of the body portion and the shank portion, commonly referred to as an “inception location”. The grind forms a desired helical flute grove and associated helical flute face and/or helical cutting edge. Cutting tools are known in the art and several examples are disclosed in U.S. Pat. No. 6,007,026, to Shorey; U.S. Pat. No. 5,190,420, to Kishimoto et al.; U.S. Pat. No. 4,810,136, to Paige; U.S. Pat. No. 4,285,618, to Shanley, Jr.; and U.S. Pat. No. 6,234,725 to Campian, the entire contents of which are incorporated herein by reference for all purposes. The known tools have continuous helical flutes with continuous cutting edges.

Generally it is known to use a rotary cutting tool to mill various types of materials. However, some materials are generally known to be much more challenging to perform roughing and finishing cutting processes thereon due to the unique characteristics of the particular material. For quite some time there remains a significant challenge to develop a cutting tool for use in the roughing and finishing of foam and/or polymeric molded materials. The cutting or milling of a foam and/or polymeric molded material can be particularly challenging because the material is relatively pliable and the cutting of the material can cause the workpiece to stretch or move significantly as the material is being cut away. This can lead to adverse results in the cutting process and the failure of the workpiece to achieve the desired net result. Further, the processing of the chips from the material is more challenging due to the relatively pliable nature of the material and can lead to clogging of the chips in the cutting tool further adversely affecting the cutting operation of the foam. Despite the long felt need for a cutting tool that can perform roughing and finishing cutting on foam in a more efficient and effective manner, no such cutting tools is known. It would still be desirable to provide an improved rotary cutting tool having greater cutting efficiency, particularly across the entire cutting length of the tool. It would also still be desirable to provide an improved rotary cutting tool without excess cut material build up on the tool.

Some cutting tools are known to not include a cutting edge with a constant distance from a center of the cutting tool. U.S. Pat. No. 3,775,819, issued on Dec. 4, 1973, includes a cutting edge and low points which cause the tool to have a smaller radius in the areas of the low points as compared to the cutting edge. However, measuring the image of U.S. Pat. No. 3,775,819, FIG. 15, any gap between the low points and a height of the illustrated cutting edge is only approximately 8% of a total height of the illustrated flute. As a result, the front side of the illustrated tool is approximately 92% solid tool, and any gap between the illustrated low point and a maximum cutting radius of the tool is largely insignificant and does not permit a significant amount of excess cut material to bypass the flute.

### SUMMARY

A rotatable cutting tool includes an elongate body having a longitudinal axis, a proximal end and a distal end and at least one helical flute extending over a length of the elongate body, the helical flute having a first end and a second end. The flute includes a cutting-edge with a first radius from a longitudinal center of the cutting tool, a trailing edge with a second radius from a longitudinal center of the cutting tool, wherein the second radius is smaller than the first radius, a flute surface between the cutting-edge and the trailing edge, the flute surface including a maximum radius at the cutting-edge and a plurality of foam chip shedding exclusions spaced along the cutting-edge of the helical flute, each of the foam chip shedding exclusions providing a gap in the cutting-edge where the radius within the gap is smaller than the first radius. The first radius defines a maximum tool cutting radius for the cutting tool. A gap distance between the foam chip shedding exclusions and the maximum tool cutting radius equals at least 15% of a radial height of the flute.

### BRIEF DESCRIPTION OF THE DRAWINGS

One or more embodiments will now be described, by way of example, with reference to the accompanying drawings, in which:

FIG. 1 is a graphic side image view of an exemplary embodiment of a cutting tool according to the present disclosure;

FIG. 2 is a partial graphic image view of the exemplary embodiment of the cutting tool of FIG. 1 according to the present disclosure;

FIG. 3 is a partial, perspective graphic image view of the cutting tool of FIG. 1 showing the detail of the flutes according to the exemplary embodiment of the present disclosure; and

FIG. 4 is a partial, perspective graphic image view of the distal end of the cutting tool of FIG. 1 show further showing the details of the flutes according to the exemplary embodiment of the present disclosure.

FIG. 5 is a perspective graphic image view of a first mill end tool for coupling to the distal end of the cutting tool of FIG. 1 according to the exemplary embodiment of the present disclosure.

FIG. 6 is a perspective graphic image view of a second mill end tool for coupling to the distal end of the cutting tool of FIG. 1 according to the exemplary embodiment of the present disclosure.

FIG. 7 is a side graphic image view of an alternative embodiment of a cutting tool, the cutting tool including a helix pattern of single cutting-edge flutes including foam chip shedding exclusions, according to the exemplary embodiment of the present disclosure.

FIG. 8 is a perspective graphic image view of the cutting tool of FIG. 7, illustrating an end of the tool and details in greater magnification, according to the exemplary embodiment of the present disclosure.

FIG. 9 is a cross-sectional view of a portion of the cutting tool of FIG. 7, illustrating details of flutes and the associated cutting-edges and foam chip shedding exclusions, according to the exemplary embodiment of the present disclosure.

FIG. 10 is a side graphic image view of an additional alternative embodiment of a cutting tool, the cutting tool including a helix pattern of double cutting-edge flutes including foam chip shedding exclusions, according to the exemplary embodiment of the present disclosure.

FIG. 11 is a perspective graphic image view of the cutting tool of FIG. 10, illustrating an end of the tool and details in greater magnification, according to the exemplary embodiment of the present disclosure.

FIG. 12A is a cross-sectional view of a portion of the cutting tool of FIG. 10, illustrating details of flutes and the associated cutting-edges and foam chip shedding exclusions including a foam chip shedding exclusion illustrated in section on a leading cutting-edge, according to the exemplary embodiment of the present disclosure.

FIG. 12B is a cross-sectional view of a portion of the cutting tool of FIG. 10, illustrating details of flutes and the associated cutting-edges and foam chip shedding exclusions including a foam chip shedding exclusion illustrated in section on a trailing cutting-edge, according to the exemplary embodiment of the present disclosure.

FIG. 13 illustrates a flute according to the cutting tool of FIG. 7 including a cutting-edge, a flute trailing edge, and a foam chip shedding exclusion including a semi-spherical profile as would be created by using a ball-nosed mill to create the exclusion, as viewed from directly over the flute, according to the exemplary embodiment of the present disclosure.

FIG. 14 illustrates flutes according to the cutting tool of FIG. 10 including a leading cutting-edge, a trailing cutting-edge, and foam chip shedding exclusions corresponding to each of the cutting-edges including a flat profile as would be created by using a flat-tipped mill to create the exclusion, as viewed from directly over the flute, according to the exemplary embodiment of the present disclosure.

FIG. 15 illustrates through a data graph a maximum radial distance from a center of a cutting tool along a distance of a single flute of the cutting tool of FIG. 7, according to the exemplary embodiment of the present disclosure;

FIG. 16 illustrates an exemplary flute in sectioned profile of a cutting tool known in the prior art without any foam chip shedding exclusions, in accordance with the present disclosure;

FIG. 17 illustrates the flute of FIG. 16 with pieces of foam stacking up in front of the edge, in accordance with the present disclosure;

FIG. 18 illustrates an exemplary flute in profile of a cutting tool known in the prior art with a limited low point in the flute, in accordance with the present disclosure;

FIG. 19 illustrates the flute of FIG. 18 in magnified detail, in accordance with the present disclosure;

FIG. 20 illustrates an exemplary flute in sectioned profile of a cutting tool including a foam chip shedding exclusion configured to permit foam chips to pass from a front side of the flute to a back side of the flute, in accordance with the present disclosure;

FIG. 21 illustrates the flute of FIG. 20 in sectioned profile, with foam chips passing through the foam chip shedding exclusion from the front side of the flute to the rear side of the flute, in accordance with the present disclosure;

FIG. 22 illustrates an exemplary flute in sectioned profile of a cutting tool including a foam chip shedding exclusion, wherein an exclusion to maximum cutting radius distance occurs at a rear side of the flute, in accordance with the present disclosure;

FIG. 23 illustrates an exemplary flute in sectioned profile of a cutting tool including a foam chip shedding exclusion, wherein an exclusion to maximum cutting radius distance occurs at a front side of the flute, in accordance with the present disclosure;

FIG. 24 illustrates an exemplary prior art cutting tool including a positive cutting angle cutting through an exemplary foam workpiece, in accordance with the present disclosure;

FIG. 25 illustrates an exemplary cutting tool including foam chip shedding exclusions, a negative cutting angle, and a hollow core configured to draw foam chips there through by application of low air pressure within the hollow core, in accordance with the present disclosure;

FIG. 26 illustrates an additional exemplary embodiment of a foam chip shedding exclusion upon a flute of a cutting tool, in accordance with the present disclosure; and

FIG. 27 illustrates an exemplary flute in sectioned profile of a cutting tool including a variety of foam chip shedding exclusion depths, in accordance with the present disclosure.

### DETAILED DESCRIPTION

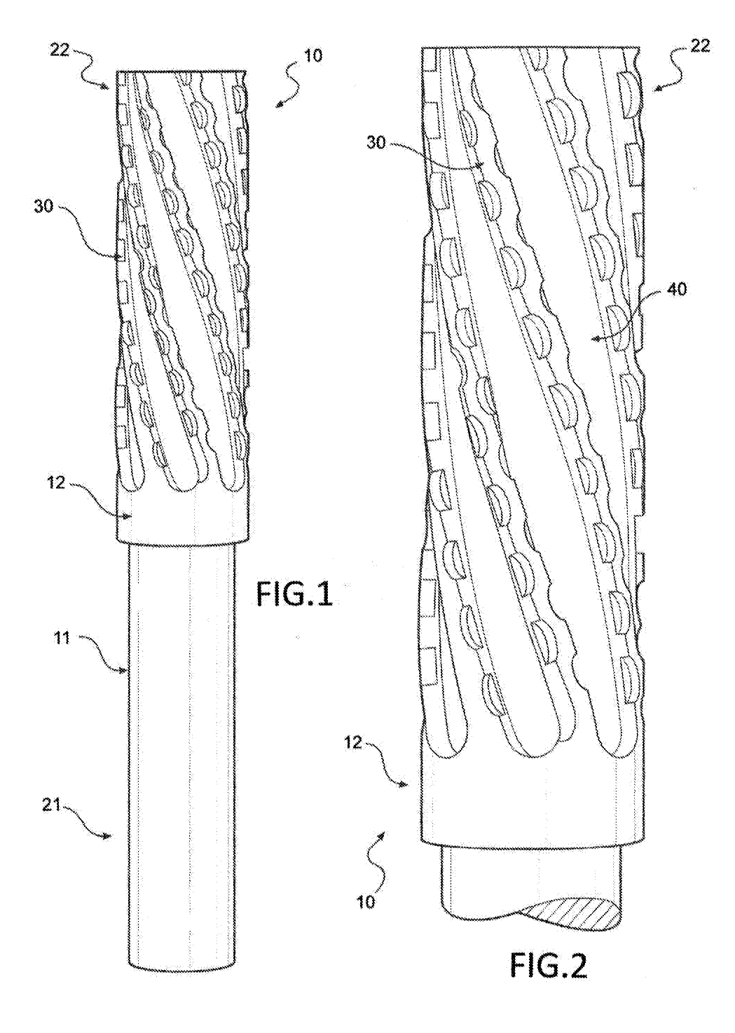

Referring now to the drawings, wherein the showings are for the purpose of illustrating certain exemplary embodiments only and not for the purpose of limiting the same, and in particular to FIG. 1, the present disclosure and teachings described herein relate to a cutting tool 10 having particular application in the use of milling a foam material such as may be used for a vehicle seat foam pad or the like. The cutting tool 10 has particular efficiency and effectiveness when used in milling a foam material composed of polyurethane foam or similar material. Such known materials have particular application in a variety of industries and products, including in particular, the automotive industry for producing a sample part, such as an engine component or the like (i.e., workpiece). While the present disclosure is done in reference to the workpiece being formed from a polymeric block of material for use as an engine block for use in a vehicle, this is only done by way of example and is not intended to be limiting in any manner. The rotary cutting tool 10 disclosed herein may be used in the milling of foam and/or polymeric or similar type foam castings and plastic molded workpieces for use III any appropriate known or future applications.

Figure labels in the various drawings are each abbreviated with the designation “FIG.” Referring in particular to FIG. 1, there is disclosed a cutting tool 10 including a shank portion 11 and a body portion 12. The cutting tool 10 may be formed from a blank of generally cylindrical stock and may be formed, machined or otherwise made into the final shape as shown. In one particular exemplary embodiment, the blank from which the cutting tool 10 is made includes a first portion having a smaller outer diameter portion and a second portion having a larger diameter. The cutting tool 10 includes a first or proximal end 21 and a second or distal end 22. The cutting tool 10 has a generally elongate shape including a longitudinal axis about which the cutting tool 10 may be rotated to perform a milling operation on a workpiece (not shown). The cutting tool 10 may include a plurality of flutes 30 having a generally helical shape and extending over an axial extent of the body portion 12 as best shown in FIG. 2. The flutes 30 may extend over as little or as much of the body portion 12 as may be desired or appropriate for a given application.

In the exemplary embodiment of the cutting tool 10 illustrated in the Figures, the cutting tool 10 includes a shank portion 11 and a body portion 12 extending in a longitudinal direction away from the shank portion 11 and together defining a longitudinal axis of the cutting tool 11. The cutting tool 10 is formed to include a plurality of flutes 30 extending along the body portion 12. The flutes 30 may be generally formed, such as by grinding two channels or sides of a flute groove 40 located between two flutes 30 of the cutting tool 10. The flute groove is defined by two opposing walls 33 and 34 along the flute groove 40 which are either a leading wall 33 or trailing wall 34 depending upon the direction of rotation of the cutting tool 10. The forming or grinding of opposing walls 33 and 34 of the flutes 30 extends from a point or distal from end 22 and proximal the shank portion 11 and may be discontinued at or near the boundary of the body portion 12 and the shank portion 11. It will be appreciated that the direction of the forming or grinding of the flutes 30 may be reversed. As may be seen in the exemplary embodiment of the present disclosure, the cutting tool 10 may include seven flutes 30 forming the milling tool 10, and the seven flutes 30 may wind helically around the body portion 12 of the milling tool 10 and may define the six flute grooves 40. It is possible to have fewer or greater numbers of flutes 30 as may be appropriate for a given application or objective.

In one particular exemplary embodiment of the present disclosure, the flutes 30 may be formed at a helix angle which “winds” around the cylindrical body portion 12 of approximately 30° (thirty degrees) from the longitudinal axis of the cutting tool 10. For a cutting tool 10 as disclosed, a “low helix” (or low helical flute) is a flute 30 that helically “winds” around the body portion or cylinder 12 at an angle of no more than approximately 20° (twenty degrees) from the longitudinal axis of the cutting tool 10. A “high helix” (or high helical flute) is a flute 30 that helically winds around the generally cylinder-shaped body portion 12 at an angle of greater than approximately about 30°. Low helix angle flutes 30 may be typically employed for rough cutting while high helix angle flutes may be typically employed for a finer finish cutting. In one particular exemplary embodiment of the present disclosure, it is believed that a particularly effective milling tool 10 may include flutes 30 formed at a helix angle of between approximately 20° (twenty degrees) and approximately 30° (thirty degrees) from the longitudinal axis of the cutting tool 10.

Referring now in general to FIGS. 1 through 4, the unique flutes 30 of the cutting tool 10 according to the present disclosure are shown in greater detail. Each flute 30 includes a first or leading edge 31 and a second or trailing edge 32 associated with the leading wall 33 and the trailing wall 34 of the cutting tool 10. Each flute 30 may be separated by the flute groove 40 that is formed to include a base surface 41 that is a generally and substantially flat and arcuate surface having a center located on the longitudinal axis of the cutting tool 10. The direction of rotation of the cutting tool 10 is chosen based upon the angular offset of the helical flutes 30 and grooves 40 from the longitudinal axis of the cutting tool 10 so that the chips removed from the foam workpiece follow the flute groove 40 away from the workpiece as the cutting tool 10 rotates. The helix shaped flutes 30 and helix shaped flute grooves 40 of the present embodiment may be angled in an opposite direction from the longitudinal axis of the cutting tool 10 as shown in the Figures.

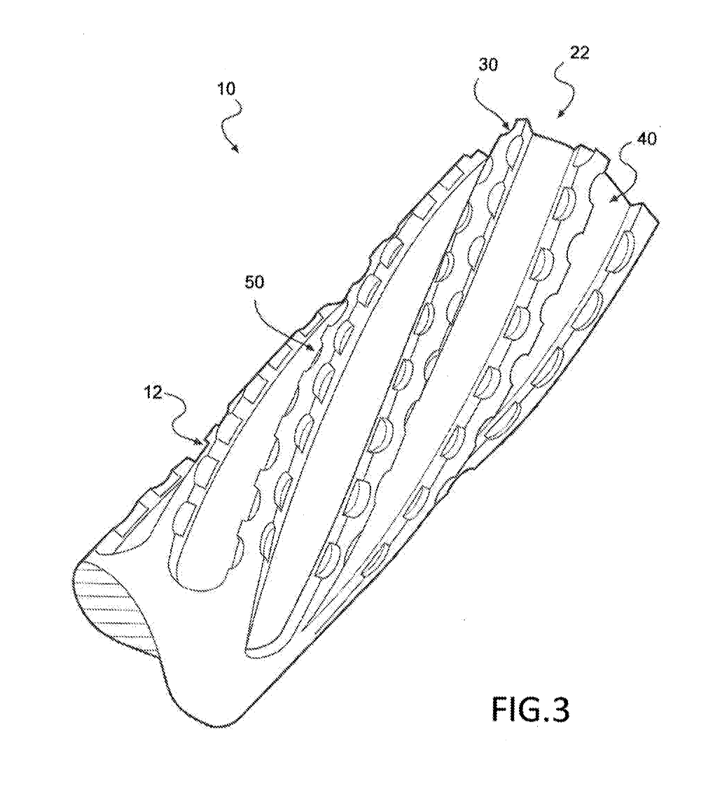

Each flute 30 further includes a flute surface 50 generally extending from the leading-edge to the trailing edge of the flute 30. Each flute surface 50 further includes a first cutting edge 31 and a second cutting edge 32. The first cutting-edge 31 is generally aligned with one of the leading edge and the trailing edge of the flute 30 and the second cutting edge is generally aligned with the other of the leading edge and the trailing edge of the flute 30. The cutting tool 10 of the present disclosure is a multi-flute helix cutter with dual cutting-edges on the same flute 30 and has particular benefits and efficiencies when used to cut a foam workpiece as best shown in FIG. 3.

More particularly, the cutting tool 10 of the exemplary embodiments of the present disclosure includes a multi-flute helix cutter and having dual cutting-edges on the same flute 30 that is interrupted by offset and has particular benefits and efficiencies when used to cut a foam workpiece as best shown in FIG. 3.

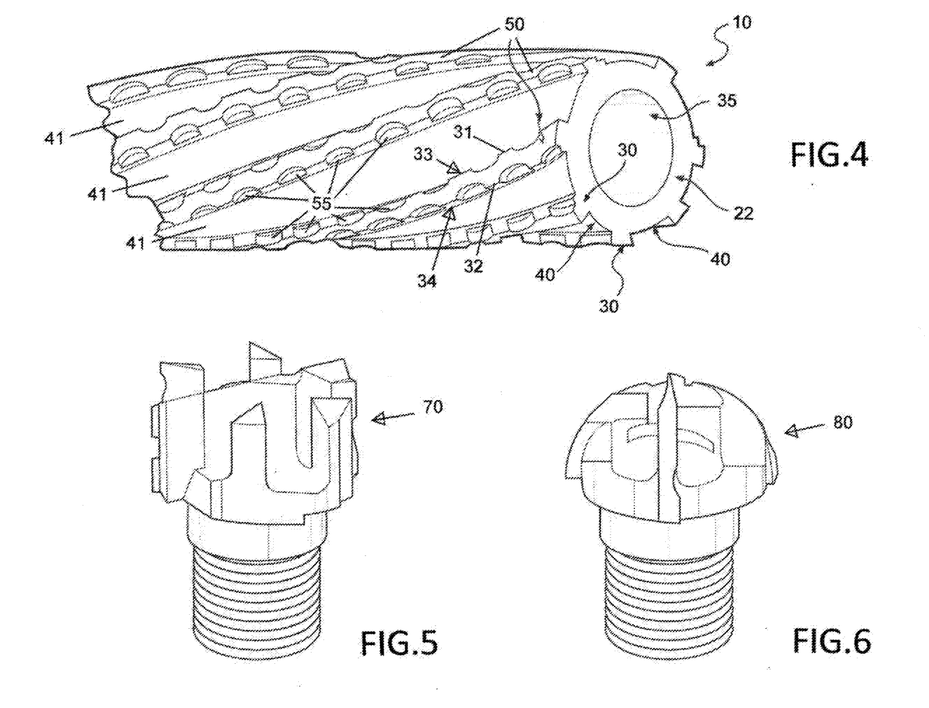

Referring now in particular to FIG. 4, the second or distal end 22 is shown in greater detail. The outline of each flute 30 is also shown in greater detail. In particular, the flutes 30 include and are defined by a leading wall 33 and a trailing wall 34 that may each be angled with respect to a floor 41 of the flute groove 40. In particular, the leading wall 33 of the flute 30 may be angled with respect to the floor 41 of the flute groove 40 at an angle of substantially ninety degrees (90°) from a ray perpendicular to the longitudinal axis of the cutting tool 10. Similarly, the trailing wall 34 of the flute 30 may be angled with respect to the floor 41 of the flute groove 40 at an angle of substantially ninety degrees (90°) from a ray perpendicular to the longitudinal axis of the cutting tool 10.

As shown in FIG. 4, the cutting tool 10 may also include a partially-hollow cross-section defining a passage 35 having a generally round cross-section and that may extend along the longitudinal axis of the cutting tool 10. Typically, the passage 35 will extend along at least a portion, if not the entire, body portion 12 of the cutting tool 10 from the end 22 and toward the shank 11. By having a hollow cutting tool 10, the mass of the cutting tool is 10 is reduced and therefore may require less energy to rotate at a given speed.

In one exemplary embodiment according to the present disclosure, the end of the passage 35 near the end 22 of the cutting tool 10 may, in one exemplary embodiment of the present disclosure, be threaded for receiving at least one of the first and second threaded end cutters 70 and 80 as those shown in FIGS. 5 and 6, respectively. In particular, FIG. 5 discloses an end mill or square foam cutter head 70 that may be threadingly engaged to the threaded passage 35 in the end 22 of the cutting tool 10. FIG. 6 discloses a ball (or hemispherical) nose type foam cutter head 80 that may be similarly designed to be readily engaged to the threads of the passage 35 in end 22 of the cutting tool 10. It should be appreciated that other shapes and sizes of cutter heads may be threaded to the end 22 of the cutting tool 10. Further, it should be appreciated that other types of coupling, connecting or fastening devices or mechanisms may be used for coupling an end mill to the cutting tool 10.

According to an exemplary embodiment of the present disclosure the cutting tool 10, the shank portion 11 and body portion 12 may be formed using any known or appropriate process and/or material, including in one exemplary embodiment, a metal material such as steel or steel alloy. The cutting tool 10 may preferably be formed including the hollow passage 35. The flutes 30 may be formed, produced or machined in the body portion 12 using any known or appropriate process including either removal and/or addition of material to the body portion 12. The flutes 30 may be formed to include the leading wall 33 and trailing wall 34 as well as the leading and trailing cutting edges 31 and 32, respectively, of the flute 30. The flute 30 may further include the generally flute surface 50 located on the distal end of each flute 30 and extending between the leading cutting-edge 31 and the trailing cutting edge 32 of flute 30.

The leading wall 33 and trailing wall 34 of each flute 30 may be machined to have a preferred angle from the normal direction to the longitudinal axis of the cutting tool 10. In one particular exemplary embodiment of the present disclosure, the scallop-shaped or half-round recesses, reliefs or cut-outs 55 may be formed in the surface 50 of each flute 30 using any known or appropriate forming process including a machining or milling. More particularly, in one exemplary embodiment, each relief 55 may be formed in the flute 30 using a drilling procedure appropriate to create the approximately half-round reliefs 55 as shown. A plurality of reliefs 55 may be generally evenly spaced along each leading cutting edge 31 and trailing cutting edge 32 of each flute 30. Each relief 55 may preferably have a uniform depth of approximately one-half (½) in its respective leading wall 33 or trailing wall 34 of the flute 30. Each relief 55 should have more than an insubstantial depth and a depth of less than one hundred percent (100%) of the height of the leading and trailing walls 33 and 34, respectively. More particularly, in one exemplary embodiment according to the present disclosure, each relief 55 may have a depth of between approximately twenty-five percent (25%) and seventy-five percent (75%) of the height of its respective wall. Even more particularly, in one exemplary embodiment according to the present disclosure, each relief 55 may have a depth of approximately 50% of the height of its respective wall of the flute 30. In one particular exemplary embodiment, the walls of the flute 30 may have a height of approximately thirty thousandths (0.030) of an inch and each relief 55 may have a depth of between approximately ten thousandths (0.010) and fifteen thousandths (0.015) of an inch.

In one particular exemplary embodiment according to the present disclosure, as best shown in FIG. 3 the reliefs 55 of the trailing edge 32 of the flute 30 may preferably be offset a predetermined amount from the reliefs 55 of the leading edge 31 of each flute 30. In one particular exemplary embodiment according to the present disclosure, the reliefs 55 of the trailing edge 32 of the flute 30 may preferably be offset fifty percent (50%) so that the center of the reliefs 55 on the trailing edge 32 are evenly spaced between the reliefs 55 of the leading edge 31 of each flute 30.

In one exemplary embodiment of the present disclosure, the reliefs 55 on each flute 30 are located in a staggered from one flute 30 to the next flute 30 such that as the cutting tool 10 rotates, the reliefs 55 of the cutting tool 10 reasonably uniformly cover the entire surface of the workpiece. In particular, the reliefs 55 of a second flute 30 are offset a predetermined amount from the reliefs 55 of a first flute 30 based upon the total number of flutes 30 on the cutting tool 10. More particularly, the centers of the reliefs 55 of the second flute 30 are offset a predetermined amount from the centers of the reliefs 55 of the first flute 30. In one exemplary embodiment of the present disclosure, the cutting tool 10 has a first flute 30 having a first relief 55 having a center at the very end (or zero point) of the flute 30, then the center of the first relief 55 of the next flute 30 will be shifted a predetermined amount equal to the distance between the reliefs 55 on the first flutes 30 divided by the total number of flutes 30. Of course, the predetermined spacing of the reliefs 55 from one flute 30 to another flute 30 in this particular embodiment and design is premised on the reliefs 55 being spaced equidistant along each flute 30. It is contemplated that it is possible to vary the spacing of the reliefs 55 along the flutes 30 of the cutting tool 10 such that the reliefs 55 are staggered to provide a similar effective complete distribution and overlap of the reliefs 55 the length of the cutting portion of the cutting tool 10.

With the reliefs 55 formed in the flutes 30, it can be seen that the reliefs 55 interrupt the cutting-edges 31 and 32 of the flutes 30 and work in conjunction with the remaining portions of the leading and trailing edges 31 and 32, respectively, to provide an improved foam cutting tool 10. Accordingly, forming the reliefs 55 in the flutes 30 causes the cutting-edge to be generally evenly interrupted along the leading and trailing edges 31 and 32, respectively, of each flute 30 during milling of the foam workpiece resulting in a better quality foam cut and produced or finished workpiece thereby saving time, expense and effort because post milling operations are significantly reduced and/or eliminated.

Any numerical values recited herein or in the Figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes, The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps, The disclosure of “a” or “one” to describe an element, ingredient, component or step is not intended to foreclose additional elements, ingredients, components or steps.

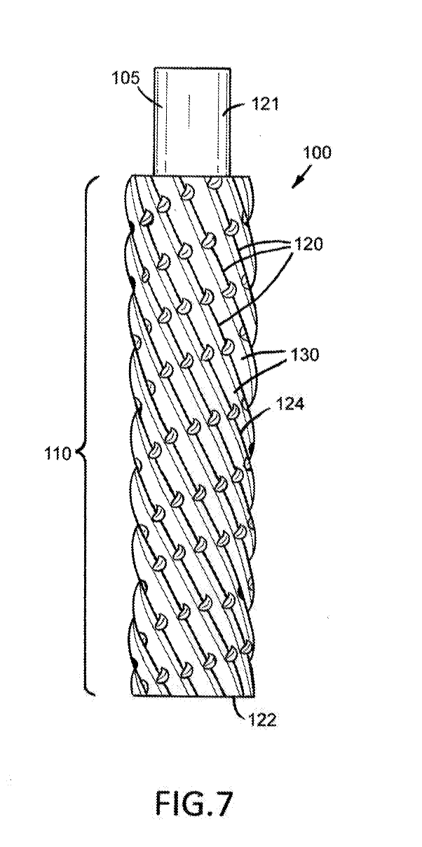

FIG. 7 is a side graphic image view of an alternative embodiment of a cutting tool, the cutting tool including a helix pattern of single cutting-edge flutes including foam chip shedding exclusions, according to the exemplary embodiment of the present disclosure. Cutting tool 100 is illustrated including a first or proximal end 121 and a second or distal end 122. First end 121 includes a shank portion 105 configured to be held within a machining device. Second end 122 includes cutting features 110 useful to cut through polymerized foam, such as are used to make exemplary automotive seat cushions, and similar materials. Cutting tool 100 is illustrated configured to be rotated such that visible features would translate from right to left in FIG. 7. Flutes 120 are provided arrayed around an outer surface of the cutting tool 100, arranged in a helix pattern, and in the embodiment of FIG. 7, in a reverse helix pattern which is configured to push foam chips created in the foam cutting process toward second end 122. Each flute 120 is characterized with a single cutting-edge 124. Each cutting-edge 124 includes a sharpened edge which is formed around an outer perimeter of cutting tool 100. Each cutting-edge 124 is at a constant, maximum radial distance from a longitudinal axis of tool 100, such that as the tool turns, any given point on the cutting-edges 124, if viewed from second end 122, would orbit about the center of the tool in a circle defined by the radius of the cutting-edges 124 from the center of the tool. A center of the tool or a longitudinal axis, as described herein, is intended to describe the line about which the cylindrical tool nominally is configured to spin about.

Cutting-edges 124 running along the length of cutting tool 100 at a constant radius from a center of the tool create a cavity in a work piece at a width of two times the radius of the tool. The cutting-edges 124 mill away the exemplary foam material from the work piece in the profile of the spinning tool as presented by the spinning helix pattern of the cutting-edges 124. If a cutting tool similar to cutting tool 100 with cutting-edges 124 presenting an unbroken line of cutting-edges is used to mill a work piece, shavings or chips from the work piece cannot slip past the cutting-edges between the cutting-edges and the neighboring work piece. The chips are instead pushed downward towards an end of the work piece. While tools made for cutting rigid materials such as metal or wood can push shavings along to the tool, a tool made for cutting foam will simply deform the neighboring foam in the work piece with shavings or chips as the cutting tool is turned. This can result in wavy patterns or chattering in the work piece. The disclosed cutting tool 100 includes a plurality of foam chip shedding exclusions 130 or reliefs upon each flute 120. These foam chip shedding exclusions 130 break the cutting-edges 124, creating gaps in the cutting-edges 124 that permit shavings or chips created by milling away the work piece to travel past a neighboring cutting edge 124. This passing of chips from one flute to the next relieves material stresses from between the cutting tool 100 and the neighboring work piece. In this way, work product defects such as wavy patterns and chattering can be reduced or eliminated by the location of the foam chip shedding exclusions 130 upon flutes 120.

Foam chip shedding exclusions 130 can be formed at different axial locations on each neighboring cutting-edge 124 to reduce or eliminate any visual evidence of the exclusions on the work piece.

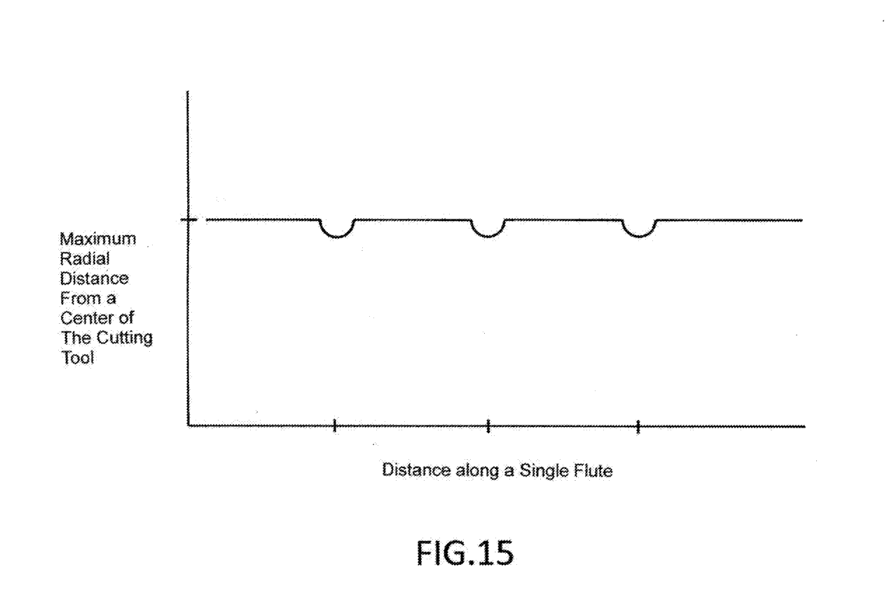

FIG. 15 illustrates through a data graph a maximum radial distance from a center of a cutting tool along a distance of a single flute of the cutting tool of FIG. 7. The vertical axis illustrates a maximum radial distance from a center of a cutting tool for features of the flute. The horizontal axis defines particular points along the length of the flute, progressing longitudinally along the associated cutting tool. A notch on the vertical axis notes a nominal, unchanging radius for the cutting-edge of the flute, which is unchanged for the cutting-edge along the length of the cutting tool. Three notches in the horizontal axis illustrate the locations of three foam chip shedding exclusions on the flute. Each foam chip shedding exclusions provides a gap in the cutting-edge or a space along the cutting-edge that foam chips can get past the cutting-edge and move to a space preceding a next flute. This relief provided by the gaps in the cutting-edge reduces material stress between the cutting tool and the neighboring work piece.

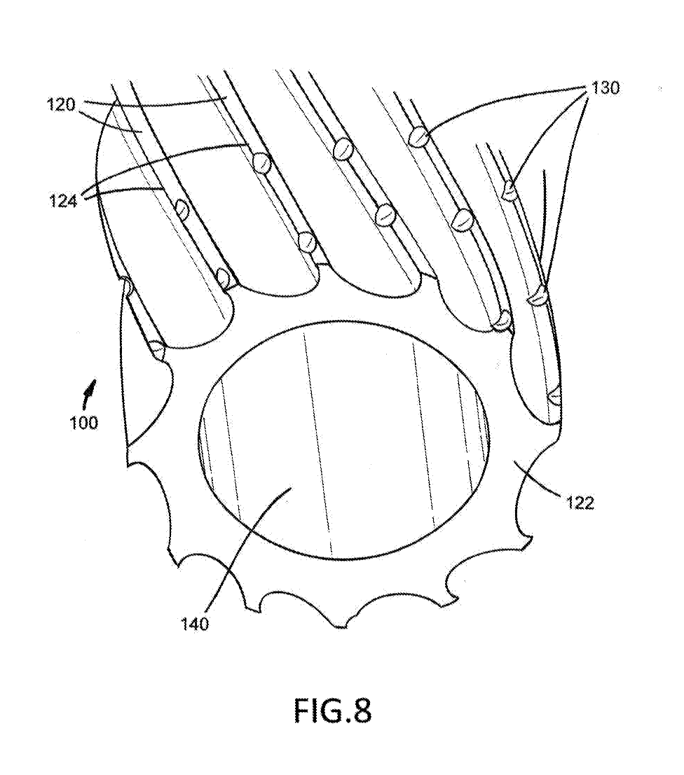

FIG. 8 is a perspective graphic image view of the cutting tool of FIG. 7, illustrating an end of the tool and details in greater magnification. Cutting tool 100 is illustrated including second end 122. Flutes 120 are illustrated including cutting-edges 124 and foam chip shedding exclusions 130. A center portion 140 of the tool can be hollow to permit application of a suction through the tool to remove work piece chips that reach a distal end of cutting tool 100.

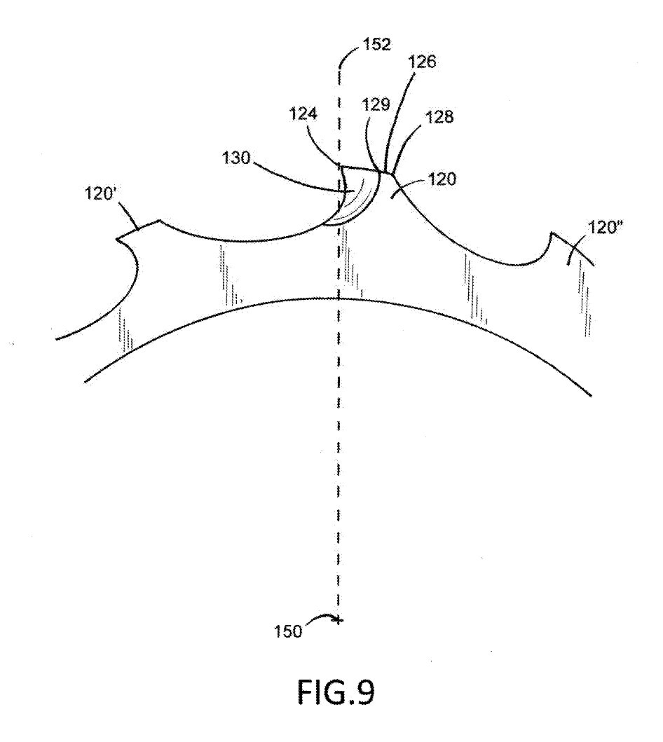

FIG. 9 is a cross-sectional view of a portion of the cutting tool of FIG. 7, illustrating details of flutes and the associated cutting-edges and foam chip shedding exclusions. The illustrated cutting tool rotates counter-clockwise in the illustration, with cutting-edge 124 of flute 120 milling away work piece material. A flute surface 126 can be defined between cutting-edge 124 and a flute trailing edge 128. Cutting-edge 124 includes a maximum radius of flute 120 away from cutting tool center 150, with flute surface 126 including decreasing radii farther away from cutting-edge 124 and closer to flute trailing edge 128. Flute 120 is shown in section at a point where a foam chip shedding exclusion 130 is centered, where material that would create the cutting edge 124 has been omitted or removed. Because the flute surface 126 at a back edge 129 of the foam chip shedding exclusion 130 has a smaller radius than cutting-edge 124, a gap exists between back edge 129 and a neighboring work piece surface, cut away by a preceding flute 120′, this gap enabling foam chips from the work piece to pass by flute 120 into a space in front of following flute 120″, thereby reducing material stress between flute 120 and the neighboring work piece. Flute 120 is illustrated with a negative rake angle, although tools including a positive or neutral rake angle can be similarly utilized.

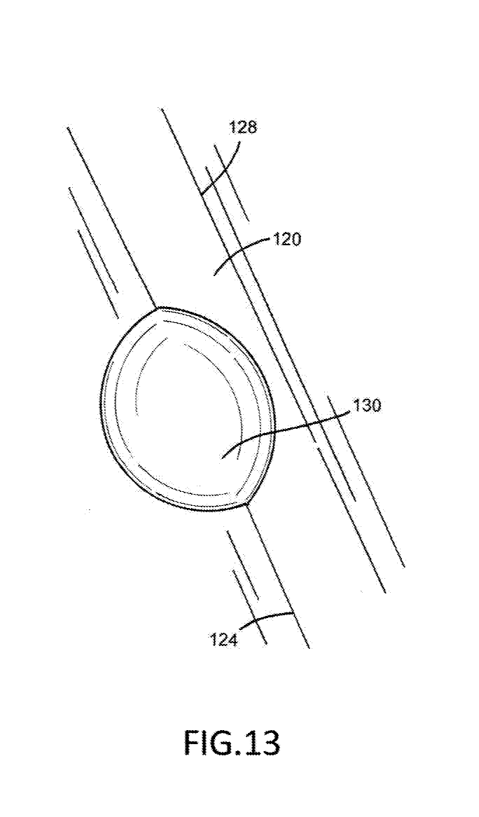

Foam chip shedding exclusions can be formed in a number of ways. In a non-limiting example, a ball-nosed mill can be pressed against a cutting tool including a flute with a cutting edge, and the foam chip shedding exclusion can be formed by removing tool material with the ball-nosed mill. In other examples a flat-tipped mill or a drill bit can be used to make the exclusion, and the disclosure is not meant to be limited to the examples provided herein. FIG. 13 illustrates a flute according to the cutting tool of FIG. 7 including a cutting-edge, a flute trailing edge, and a foam chip shedding exclusion including a semi-spherical profile as would be created by using a ball-nosed mill to create the exclusion, as viewed from directly over the flute. FIG. 13 illustrates a flute 120 including a cutting edge 124, a flute trailing edge 128, and a foam chip shedding exclusion 130 including a semi-spherical profile as would be created by using a ball-nosed mill to create the exclusion.

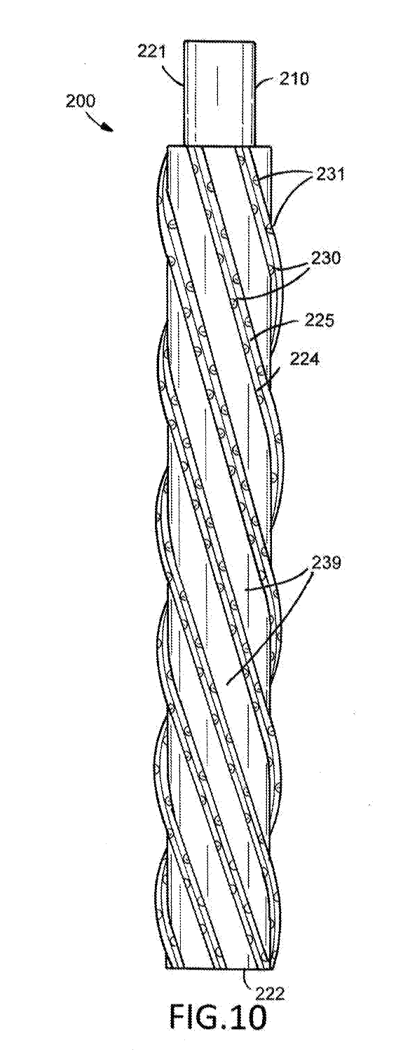

FIG. 10 is a side graphic image view of an additional alternative embodiment of a cutting tool, the cutting tool including a helix pattern of double cutting-edge flutes including foam chip shedding exclusions. Cutting tool 200 is illustrated including a first or proximal end 221 and a second or distal end 222. First end 221 includes a shank portion 210 configured to be held within a machining device. Second end 222 includes the cutting features useful to cut through polymerized foam, such as are used to make exemplary automotive seat cushions, and similar materials. Cutting tool 200 is illustrated configured to be rotated such that visible features would translate from right to left in FIG. 10. Flutes 220 are provided arrayed around an outer surface of the cutting tool 200, arranged in a helix pattern, and in the embodiment of FIG. 10, in a reverse helix pattern which is configured to push foam chips created in the foam cutting process toward second end 222. Each flute 220 is characterized with a leading cutting-edge 224 and a trailing cutting-edge 226. Each cutting-edge 224 and 226 includes a sharpened edge which is formed around an outer perimeter of cutting tool 200. Each cutting-edge 224 and 226 is at a constant, maximum radial distance from a longitudinal axis of tool 200, such that as the tool turns, any given point on cutting-edges 224 or 226, if viewed from second end 222, would orbit about the center of the tool in a circle defined by the radius of cutting-edges 224 and 226 from the center of the tool. Troughs 239 between flutes 220 are illustrated.

The cutting tool 200 includes a plurality of foam chip shedding exclusions 230 or reliefs upon leading cutting-edges 224 of flute 220 and foam chip shedding exclusions 231 upon trailing cutting-edges 226. These foam chip shedding exclusions break the associated cutting-edges, creating gaps in the cutting-edges that permit shavings or chips created by milling away the work piece to travel past a neighboring cutting-edge. This passing of chips across a cutting-edge relieves material stresses from between the cutting tool 200 and the neighboring work piece. In this way, work product defects such as wavy patterns and chattering can be reduced or eliminated by the location of the foam chip shedding exclusions 230 and 231 upon flutes 220.

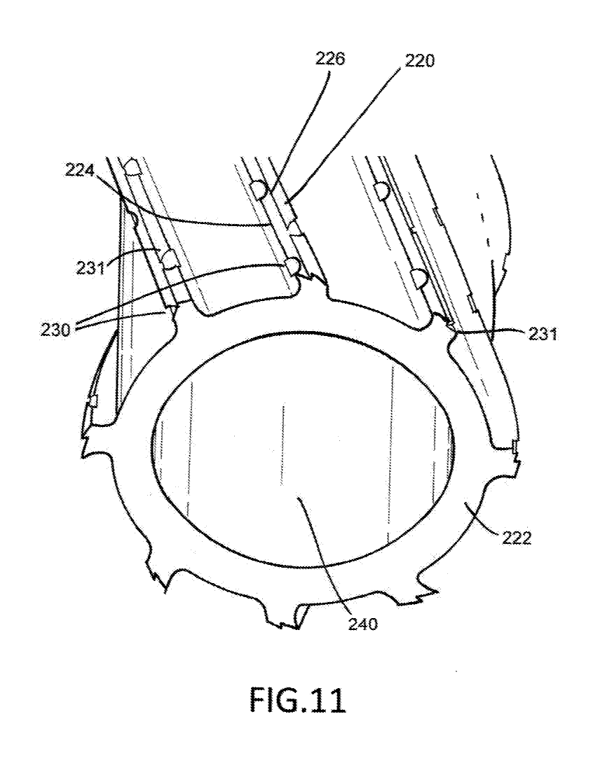

FIG. 11 is a perspective graphic image view of the cutting tool of FIG. 10, illustrating an end of the tool and details in greater magnification. Cutting tool 200 is illustrated including second end 222. Flutes 220 are illustrated including leading cutting-edges 224 and associated foam chip shedding exclusions 230. Flutes 220 are illustrated also including trailing cutting-edges 226 and associated foam chip shedding exclusions 231. A center portion 240 of the tool can be hollow to permit application of a suction through the tool to remove work piece chips that reach a distal end of cutting tool 200.

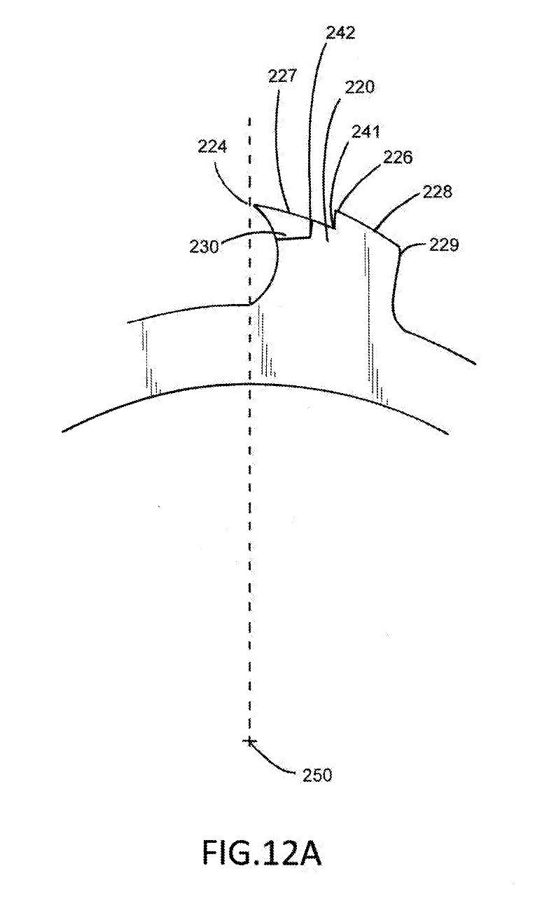

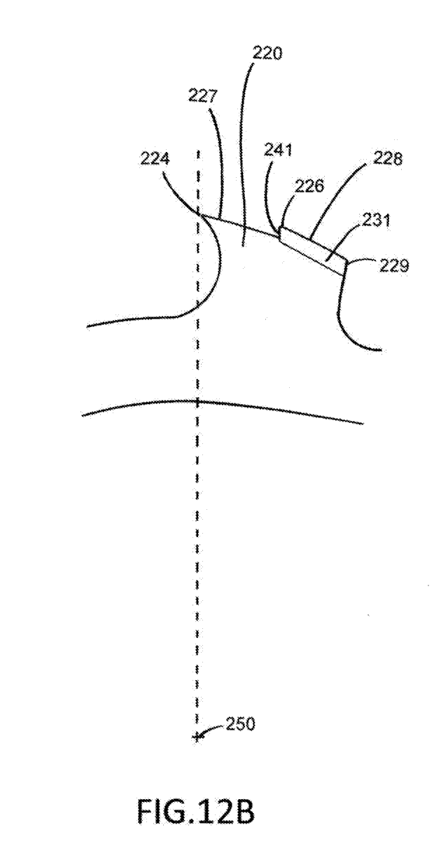

FIG. 12A is a cross-sectional view of a portion of the cutting tool of FIG. 10, illustrating details of flutes and the associated cutting-edges and foam chip shedding exclusions. The illustrated cutting tool rotates counter-clockwise in the illustration, with leading cutting-edge 224 and trailing cutting-edge 226 of flute 220 milling away work piece material. A flute surface 227 can be defined between leading cutting-edge 224 and a lowest point 241 at a vertical wall forming trailing cutting-edge 226. A second flute surface 228 can be defined between trailing cutting-edge 226 and flute trailing edge 229. Cutting-edges 224 and 226 both includes a maximum radius of flute 220 away from cutting tool center 250, with flute surface 226 including decreasing radii farther away from leading cutting-edge 224 and closer to lowest point 241. Similarly, flute surface 228 includes decreasing radii farther away from trailing cutting-edge 226 and closer to flute trailing edge 229. Flute 220 is shown in section at a point where a foam chip shedding exclusion 230 is centered, where material that would create the leading cutting-edge 224 has been omitted or removed. Because the flute surface 226 at a back edge 242 of the foam chip shedding exclusion 230 has a smaller radius than leading cutting-edge 224, a gap exists between back edge 242 and a neighboring work piece surface, cut away by a preceding flute, this gap enabling foam chips from the work piece to pass by leading cutting-edge 224 of flute 220. Flute 220 is illustrated with a negative rake angle, although tools including a positive or neutral rake angle can be similarly utilized.

FIG. 12B is a cross-sectional view of a portion of the cutting tool of FIG. 10, illustrating details of flutes and the associated cutting-edges and foam chip shedding exclusions. FIG. 12B is similar to FIG. 12A, with the exception that flute 220 is shown in section at a point where a foam chip shedding exclusion 231 is centered, where material that would create the trailing cutting-edge 224 has been omitted or removed. Because the foam chip shedding exclusion 231 takes away significant material from the trailing cutting edge 226 and flute surface 228 and has a smaller radius than trailing cutting-edge 226, a gap exists between flute 220 in the area of foam chip shedding exclusion 231 and a neighboring work piece surface, cut away by a preceding flute, this gap enabling foam chips from the work piece to pass by trailing cutting-edge 226 of flute 220.

The illustrated cutting tool rotates counter-clockwise in the illustration, with leading cutting-edge 224 and trailing cutting-edge 226 of flute 220 milling away work piece material. A flute surface 227 can be defined between leading cutting-edge 224 and a lowest point 241 at a vertical wall forming trailing cutting-edge 226. A second flute surface 228 can be defined between trailing cutting-edge 226 and flute trailing edge 229. Cutting-edges 224 and 226 both includes a maximum radius of flute 220 away from cutting tool center 250, with flute surface 226 including decreasing radii farther away from leading cutting-edge 224 and closer to lowest point 241. Similarly, flute surface 228 includes decreasing radii farther away from trailing cutting-edge 226 and closer to flute trailing edge 229. Flute 220 is illustrated with a negative rake angle, although tools including a positive or neutral rake angle can be similarly utilized.

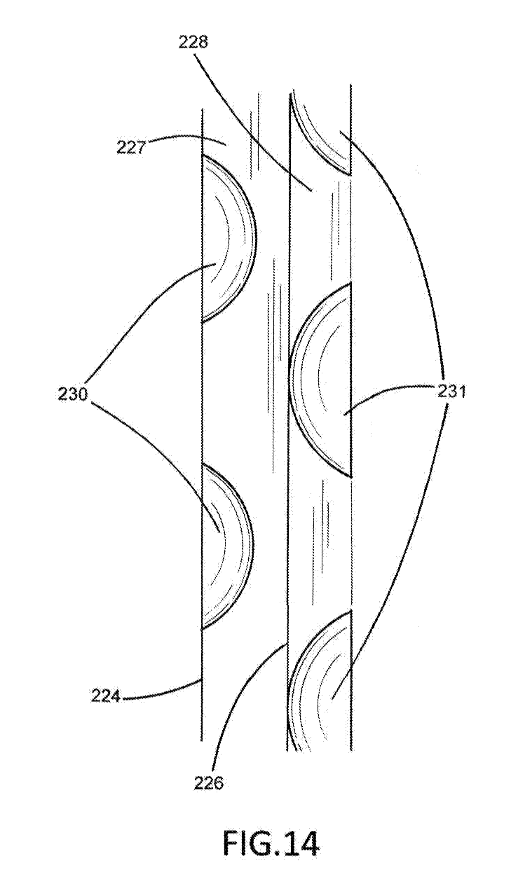

FIG. 14 illustrates flutes according to the cutting tool of FIG. 10 including a leading cutting-edge, a trailing cutting-edge, and foam chip shedding exclusions corresponding to each of the cutting-edges including a flat profile as would be created by using a flat-tipped mill to create the exclusion, as viewed from directly over the flute. FIG. 14 illustrates flute 220 including leading cutting-edge 224, trailing cutting-edge 226, and a foam chip shedding exclusion 230 and 231.

Trough areas between flutes can be any typical shape. Troughs 239 of FIG. 10 can in one embodiment be curved in cross-sectional profile, forming U-shaped troughs between the flutes. Testing has shown that U-shaped troughs can improve rejection of foam chips from the work piece.

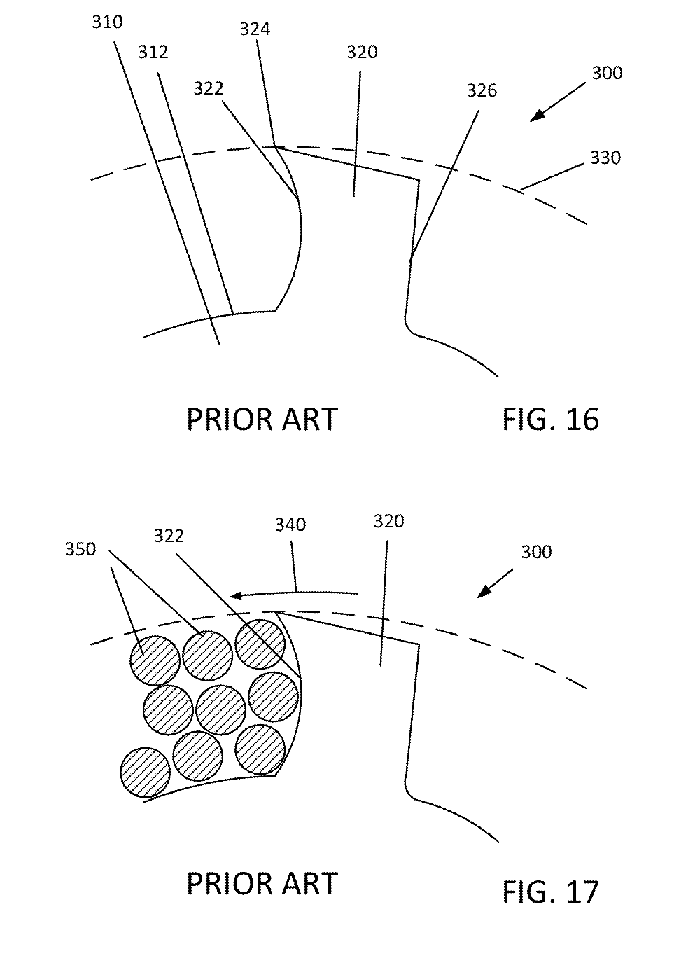

FIG. 16 illustrates an exemplary flute in sectioned profile of a cutting tool known in the prior art without any foam chip shedding exclusions. Cutting tool 300 includes a cylindrical tool body 310 including tool body surface 312. Tool 300 further includes a plurality of helical flutes 320, one of which is illustrated in cross section. Flute 320 includes cutting edge 324, front side 322, and back side 326. Each cutting edge 324 is at a constant, maximum radial distance from a longitudinal axis of tool 300, such that as the tool turns, any given point on the cutting edge 324, if viewed from an end of the tool, would orbit about the center of the tool in a circle defined by the radius of the cutting edge 324 from the center of the tool. Cutting edge 324 defines a maximum tool cutting radius 330. Maximum tool cutting radius 330 defines a path through which tool 300 cuts through a work piece. As tool 300 spins, cutting edge 324 is adjacent to and in contact with the workpiece as defined and formed by radius 330. Chips from the workpiece, created as tool 300 cuts a path through the workpiece, collect in the space between surface 312, the workpiece, and front side 322.

FIG. 17 illustrates the flute of FIG. 16 with pieces of foam stacking up in front of the edge. Toll 300 is illustrated including flute 320. Tool 300 spins in the direction of arrow 340. Foam chips 350, small pieces of a workpiece being cut by tool 300, are illustrated trapped in front of flute 320 being pushed along front side 322 of flute 320. When a cutting tool cuts through relatively heavy material such as metal or wood, inertial forces in the relatively high mass chips of metal or wood enable the helical flute of a cutting tool to move the chips easily along the longitudinal axis of the tool. However, foam chips 350 are relatively light, and their lack of significant mass causes the chips to tend to spin with tool 300 and tend to not be pushed in a longitudinal direction of the tool. Further, the foam workpiece is typically constructed of a large number of small foam balls formed into the single work piece. As the foam is cut by tool 300, foam chips 350 tend to break away from the work piece as small foam balls rather than as dust or as irregularly shaped particles. As foam chips 350 gather in front of front side 322, the chips 350 clog tool 300 and prevent the cutting edge of flute 320 from continuing to cut through the adjacent workpiece.

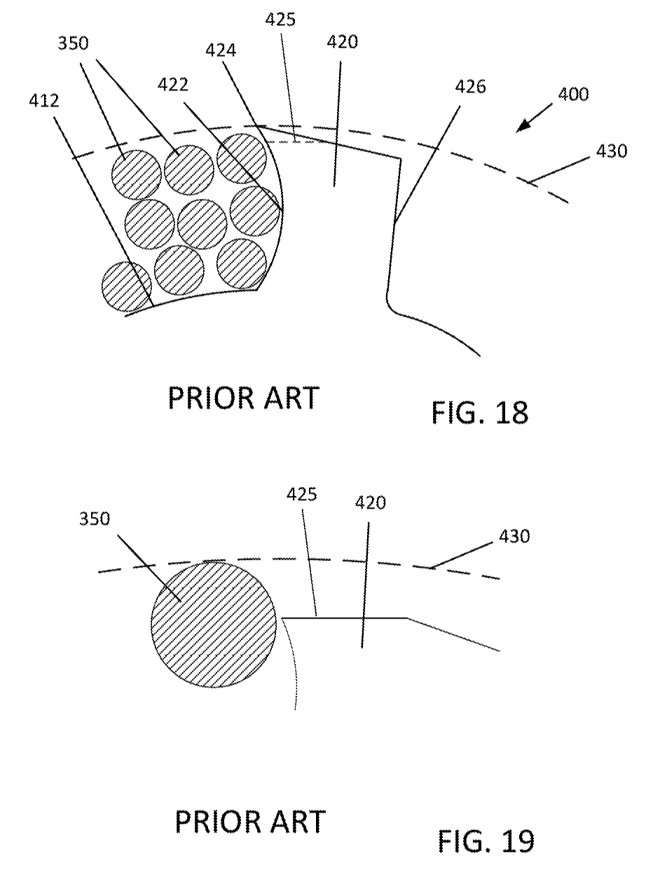

FIG. 18 illustrates an exemplary flute in sectioned profile of a cutting tool known in the prior art with a limited low point in the flute. Cutting tool 400 includes a cylindrical a tool body including a tool body surface 412. Tool 400 further includes a plurality of helical flutes 420, one of which is illustrated in cross section. Flute 420 includes cutting edge 424, front side 422, and back side 426. Each cutting edge 424 includes a maximum edge radial distance from a longitudinal axis of tool 400, such that as the tool turns, the maximum edge radius distance creates a path through a workpiece as defined by maximum tool cutting radius 430. Cutting edge 424 is not continuous along the length of tool 400, but rather includes periodic low points 425. Low point 425 leaves a gap between tool 400 and maximum tool cutting radius 430, wherein the gap equals approximately 8% of the height of flute as defined by the distance between tool body surface 412 and cutting edge 424. Foam chips 350 are illustrated grouped in front of front side 422. In some embodiments, foam chips 350, frequently including mostly foam balls separated from the foam material of the workpiece, are too large as compared to the illustrated gap to pass by flute 420 between low point 425 and maximum tool cutting radius 430.

FIG. 19 illustrates the flute of FIG. 18 in magnified detail. Flute 420 is illustrated including low point 425 and maximum tool cutting radius 430. Foam chip 350 is illustrated as a typical foam ball that can be separated from a foam workpiece and is too large to fit in a gap between low point 425 and maximum tool cutting radius 430.

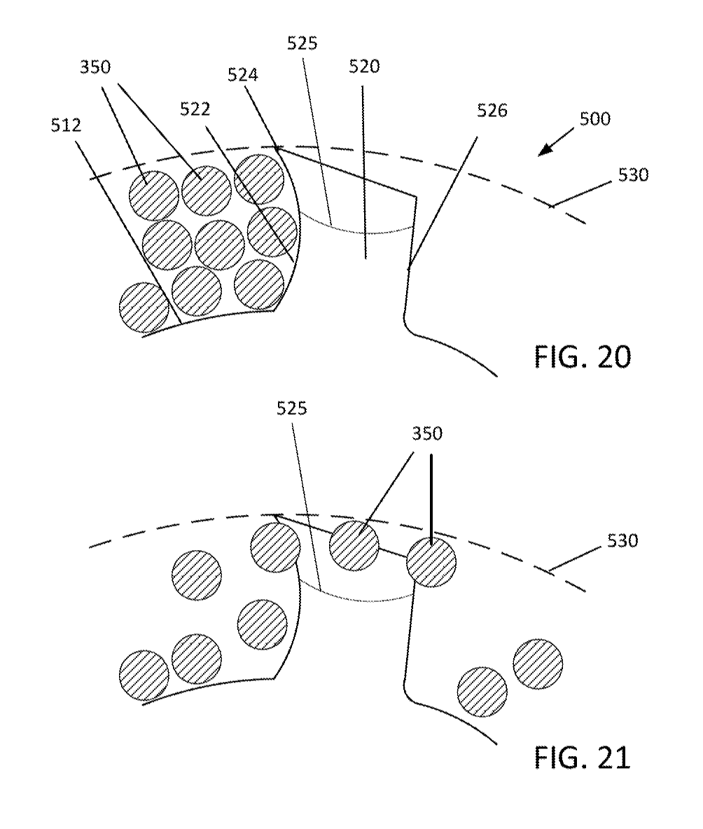

FIG. 20 illustrates an exemplary flute in sectioned profile of a cutting tool including a foam chip shedding exclusion configured to permit foam chips to pass from a front side of the flute to a back side of the flute. Cutting tool 500 includes a cylindrical a tool body including a tool body surface 512. Tool 500 further includes a plurality of helical flutes 520, one of which is illustrated in cross section. Flute 520 includes cutting edge 524, front side 522, and back side 526. Each cutting edge 524 includes a maximum edge radial distance from a longitudinal axis of tool 500, such that as the tool turns, the maximum edge radius distance creates a path through a workpiece as defined by maximum tool cutting radius 530. Cutting edge 524 is not continuous along the length of tool 500, but rather includes foam chip shedding exclusions 525. Exclusion 525 leaves a gap between tool 500 and maximum tool cutting radius 530, wherein the gap equals at least 15% of the height of flute as defined by the distance between tool body surface 512 and cutting edge 524. Foam chips 350 are illustrated grouped in front of front side 522. FIG. 21 illustrates the flute of FIG. 20 in sectioned profile, with foam chips passing through the foam chip shedding exclusion from the front side of the flute to the rear side of the flute. Foam chips 350 can pass from the front side to the back side by the gap created between exclusion 525 and maximum tool cutting radius 530. As a result, the foam chips fail to remain stacked in front of the flute and fail to prevent the cutting edge of the illustrated flute from continuing to cut through the adjacent workpiece.

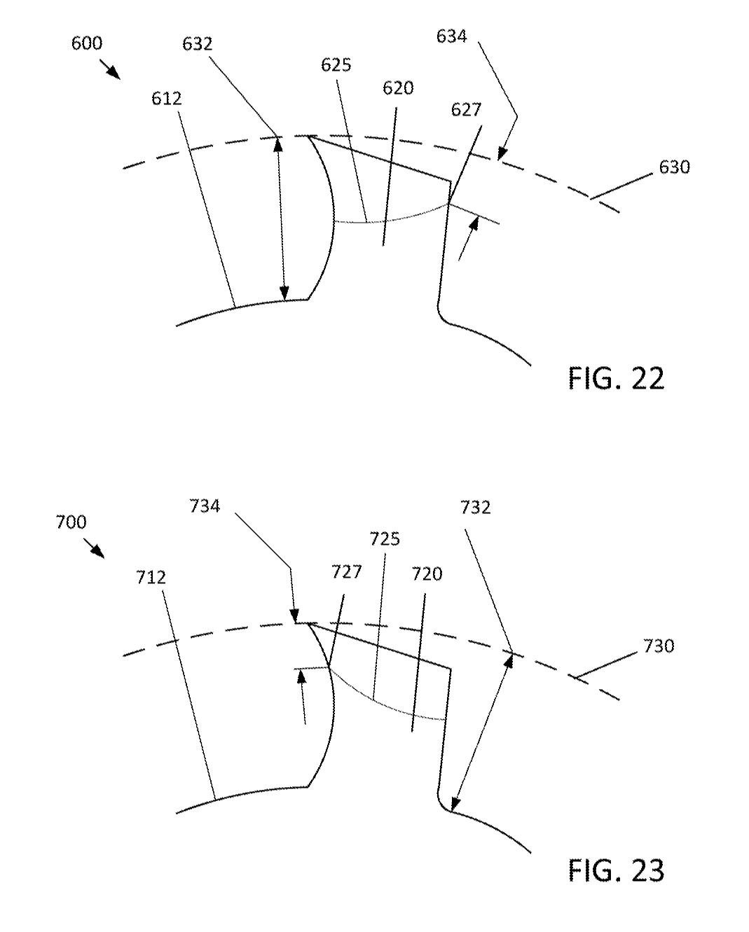

FIG. 22 illustrates an exemplary flute in sectioned profile of a cutting tool including a foam chip shedding exclusion, wherein an exclusion to maximum cutting radius distance occurs at a rear side of the flute. Cutting tool 600 includes a cylindrical a tool body including a tool body surface 612. Tool 600 further includes a plurality of helical flutes 620, one of which is illustrated in cross section. Flute 620 includes cutting edge, front side, and back side. Each cutting edge includes a maximum edge radial distance from a longitudinal axis of tool 600, such that as the tool turns, the maximum edge radius distance creates a path through a workpiece as defined by maximum tool cutting radius 630. The cutting edge is not continuous along the length of tool 600, but rather includes foam chip shedding exclusions 625. A maximum radial height of exclusion 625 is defined by point 627. Exclusion 625 leaves a gap distance 634 between point 627 and maximum tool cutting radius 630. A height of the flute 632 can be defined by the radial distance between tool body surface 612 and cutting edge or maximum tool cutting radius 630.

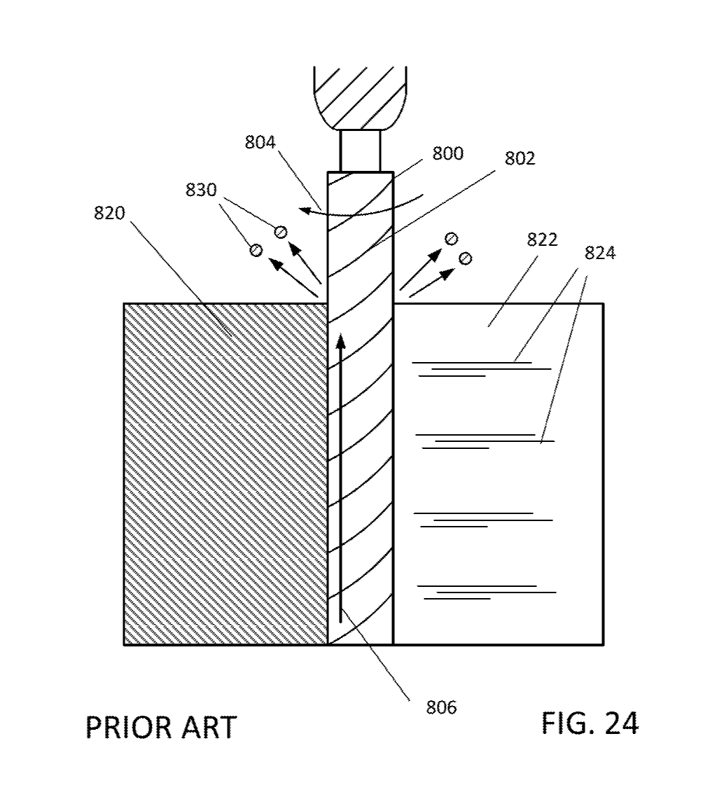

FIG. 23 illustrates an exemplary flute in sectioned profile of a cutting tool including a foam chip shedding exclusion, wherein an exclusion to maximum cutting radius distance occurs at a front side of the flute. Cutting tool 700 includes a cylindrical a tool body including a tool body surface 712. Tool 700 further includes a plurality of helical flutes 720, one of which is illustrated in cross section. Flute 720 includes cutting edge, front side, and back side. Each cutting edge includes a maximum edge radial distance from a longitudinal axis of tool 700, such that as the tool turns, the maximum edge radius distance creates a path through a workpiece as defined by maximum tool cutting radius 730. The cutting edge is not continuous along the length of tool 700, but rather includes foam chip shedding exclusions 725. A maximum radial height of exclusion 725 is defined by point 727. Exclusion 725 leaves a gap distance 734 between point 727 and maximum tool cutting radius 730. A height of the flute 732 can be defined by the radial distance between tool body surface 712 and cutting edge or maximum tool cutting radius 730.

FIG. 24 illustrates an exemplary prior art cutting tool including a positive cutting angle cutting through an exemplary foam workpiece. Cutting tool 800 is illustrated cutting through foam workpiece 820. Cutting tool 800 includes helical flutes 802 illustrated with a positive cutting angle, such that when tool 800 is spun in the direction of arrow 804, foam chips are driven longitudinally upwards along the tool in the direction of arrow 806. Foam chips 830 are illustrated being ejected from the interaction of tool 800 and workpiece 820. Because foam chips 830 stack up in front of flutes 802, the tool tends to clog and only intermittently cuts workpiece 820 or will tend to chatter while cutting workpiece 820. Cut surface 822 of workpiece 820 is illustrated. Because of foam chips 830 clogging tool 800, distortion lines 824 are illustrated formed upon cut surface 822.

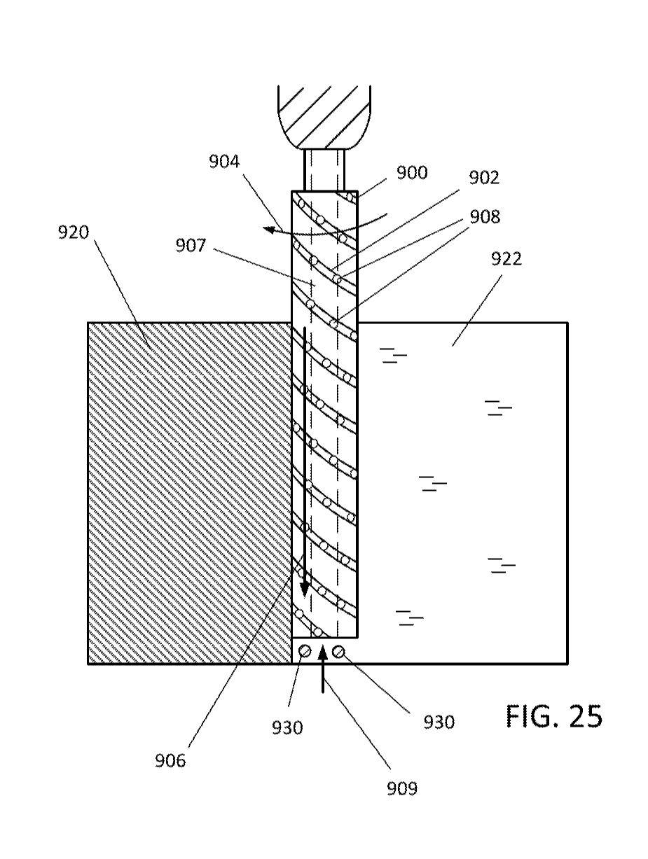

FIG. 25 illustrates an exemplary cutting tool including foam chip shedding exclusions, a negative cutting angle, and a hollow core configured to draw foam chips there through by application of low air pressure within the hollow core. Cutting tool 900 is illustrated cutting through foam workpiece 920. Cutting tool 900 includes helical flutes 902 illustrated with a negative cutting angle, such that when tool 900 is spun in the direction of arrow 904, foam chips are driven longitudinally downwards along the tool in the direction of arrow 906. Flutes 902 are illustrated including foam chip shedding exclusions 908. Foam chips 930 are illustrated being ejected from the interaction of tool 900 and workpiece 920 below tool 900. Tool 900 is illustrated including hollow core 907. The tooling machine holding tool 900 is configured to apply vacuum pressure or create low air pressure within hollow core 907, such that chips 930 can be evacuated out the area below tool 900, thereby keeping the work area between tool 900 and workpiece 920 relatively free of chips. Further, because foam chips 930 fail to stack up in front of flutes 902 because they can pass by the flutes at exclusions 908 and because chips 930 are evacuated out of the area below tool 900, the tool can cut workpiece 920 smoothly without chattering. As a result, cut surface 822 is illustrated relatively clear of distortions.

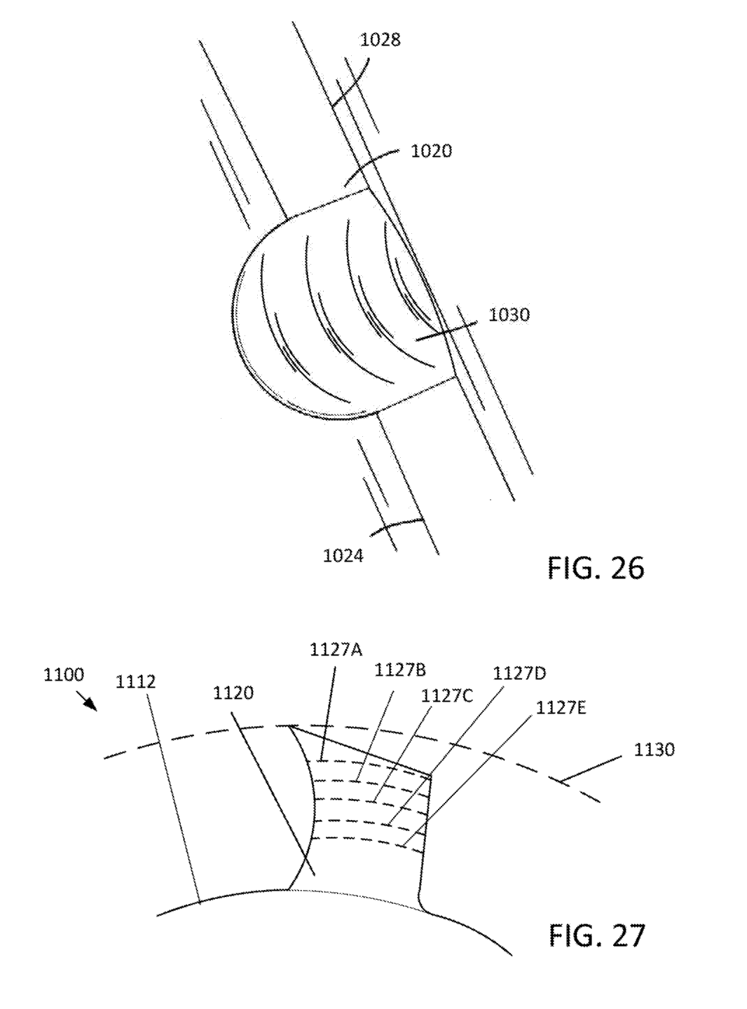

FIG. 26 illustrates an additional exemplary embodiment of a foam chip shedding exclusion upon a flute of a cutting tool. FIG. 26 illustrates a flute 1020 including a cutting edge 1024, a flute trailing edge 1028, and a foam chip shedding exclusion 1030 including a semi-cylindrical profile as would be created by translating a ball-nosed mill across flute 1020 to create the exclusion. The semi-cylindrical shape of exclusion 1030 includes straight walls consistent with the tool being held still while the ball-nosed mill moves in a straight line to make the exclusion. In another embodiment, a similar exclusion can be made with curved walls of constant radius in relation to a center of the tool by holding the ball-nosed mill in one location and slowly spinning the tool upon which the exclusions are being formed.

FIG. 27 illustrates an exemplary flute in sectioned profile of a cutting tool including a variety of foam chip shedding exclusion depths. Depending upon the size of foam balls that are used to create a foam workplace, different sizes of exclusions that create different gap sizes can be used in accordance with the disclosure. Cutting tool 1100 includes a cylindrical a tool body including a tool body surface 1112. Tool 1100 further includes a plurality of helical flutes 1120, one of which is illustrated in cross section. Flute 1120 includes cutting edge, front side, and back side. Each cutting edge includes a maximum edge radial distance from a longitudinal axis of tool 700, such that as the tool turns, the maximum edge radius distance creates a path through a workpiece as defined by maximum tool cutting radius 1130. The cutting edge is not continuous along the length of tool 1100, but rather includes foam chip shedding exclusions in accordance with the disclosure. Different size exclusions can be utilized which create different gap distances between tool 1100 and maximum tool cutting radius 1130. Exclusion surfaces 1127A, 1127B, 1127C, 1127D, and 1127E are illustrated that can be utilized that create different gap distances in accordance with exclusions disclosed herein. Exemplary exclusion surface 1127A creates a gap distance of approximately represents approximately 20% of the height of flute 1120. Exemplary exclusion surface 1127B creates a gap distance of approximately represents approximately 32% of the height of flute 1120. Exemplary exclusion surface 1127C creates a gap distance of approximately represents approximately 44% of the height of flute 1120. Exemplary exclusion surface 1127D creates a gap distance of approximately represents approximately 58% of the height of flute 1120. Exemplary exclusion surface 1127E creates a gap distance of approximately represents approximately 68% of the height of flute 1120. Depending upon the particular foam workpiece being cut by the cutting tool, exclusions that create gap distances that are at least 15% the total height of the flute can be utilized in accordance with the present disclosure.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A rotatable cutting tool, comprising:
an elongate body having a longitudinal axis, a proximal end and a distal end;
at least one helical flute extending over a length of the elongate body, the helical flute having a first end and a second end, the helical flute comprising:
a cutting-edge with a first radius from a longitudinal center of the cutting tool;
a trailing edge with a second radius from a longitudinal center of the cutting tool, wherein the second radius is smaller than the first radius;
a flute surface between the cutting-edge and the trailing edge, the flute surface including a maximum radius at the cutting-edge; and
a plurality of foam chip shedding exclusions spaced along the cutting-edge of the helical flute, each of the foam chip shedding exclusions providing a gap in the cutting-edge where the radius within the gap is smaller than the first radius;
wherein the first radius comprises a maximum tool cutting radius for the cutting tool; and
wherein a gap distance between the foam chip shedding exclusions and the maximum tool cutting radius equals at least 15% of a radial height of the flute.

2. The rotatable cutting tool of claim 1, wherein the gap distance between the foam chip shedding exclusions and the maximum tool cutting radius equals at least 20% of a radial height of the flute.

3. The rotatable cutting tool of claim 1, wherein the gap distance between the foam chip shedding exclusions and the maximum tool cutting radius equals at least 32% of a radial height of the flute.

4. The rotatable cutting tool of claim 1, wherein the gap distance between the foam chip shedding exclusions and the maximum tool cutting radius equals at least 44% of a radial height of the flute.

5. The rotatable cutting tool of claim 1, wherein the gap distance between the foam chip shedding exclusions and the maximum tool cutting radius equals at least 58% of a radial height of the flute.

6. The rotatable cutting tool of claim 1, wherein the gap distance between the foam chip shedding exclusions and the maximum tool cutting radius equals at least 68% of a radial height of the flute.

7. The rotatable cutting tool of claim 1, wherein the plurality of foam chip shedding exclusions each comprise a semi-spherical profile.

8. The rotatable cutting tool of claim 1, wherein the plurality of foam chip shedding exclusions each comprise a semi-cylindrical profile.

9. The rotatable cutting tool of claim 1, wherein the plurality of foam chip shedding exclusions comprises flat bottomed holes.

10. The rotatable cutting tool of claim 1, wherein the cutting-edge comprises a leading cutting edge; and
wherein the helical flute further comprises a second, trailing cutting-edge.

11. The rotatable cutting tool of claim 10, wherein the plurality of foam chip shedding exclusions comprises a first plurality of foam chip shedding exclusions; and
wherein the trailing cutting-edge comprises a second plurality of foam chip shedding exclusions spaced along the trailing cutting-edge.

12. The rotatable cutting tool of claim 10, comprising a plurality of helical flutes extending over the length of the elongate body; and
further comprising a U-shaped trough between each of the flutes.

13. The rotatable cutting tool of claim 1, wherein the helical flute comprises a negative cutting angle configured to push foam chips to an unfixtured end of the tool.

14. A rotatable cutting tool, comprising:
an elongate body having a longitudinal axis, a proximal end and a distal end;
at least one helical flute extending over a length of the elongate body, the helical flute having a first end and a second end, the helical flute comprising:
a cutting-edge with a first radius from a longitudinal center of the cutting tool;
a trailing edge with a second radius from a longitudinal center of the cutting tool, wherein the second radius is smaller than the first radius;
a flute surface between the cutting-edge and the trailing edge, the flute surface including a maximum radius at the cutting-edge; and
a plurality of foam chip shedding exclusions spaced along the cutting-edge of the helical flute, each of the foam chip shedding exclusions providing a gap in the cutting-edge where the radius within the gap is smaller than the first radius;
wherein the first radius comprises a maximum tool cutting radius for the cutting tool;
wherein a gap distance between the foam chip shedding exclusions and the maximum tool cutting radius equals at least 15% of a radial height of the flute; and
wherein the helical flute comprises a negative cutting angle configured to push foam chips to an unfixtured end of the tool.

15. The rotatable cutting tool of claim 1, wherein the tool is hollow.

16. The rotatable cutting tool of claim 1, wherein the plurality of foam chip shedding exclusions comprises rounded holes.
